(19) United States
(12) Patent Application Publication
(10) Pub. No.: US 2013/0279916 A1
(43) Pub. Date: Oct. 24, 2013

(54) SERVER SYSTEM AND METHOD OF PERFORMING MEMORY HIERARCHY CONTROL IN SERVER SYSTEM

(71) Applicant: SAMSUNG ELECTRONICS CO., LTD., Suwon-si (KR)

(72) Inventors: Jeong-hyeon CHO, Hwaseong-si (KR); You-keun HAN, Johns Creek, GA (US); Seung-jin SEO, Suwon-si (KR); Jung-joon LEE, Seoul (KR); Kyoung-ho HA, Seoul (KR)

(73) Assignee: SAMSUNG ELECTRONICS CO., LTD., Suwon-si (KR)

(21) Appl. No.: 13/766,881

(22) Filed: Feb. 14, 2013

(30) Foreign Application Priority Data
Apr. 19, 2012 (KR) 10-2012-0041148

(51) Int. Cl. H04B 10/2581

(52) U.S. Cl. CPC H04B 10/2581
USPC 398/115

(57) ABSTRACT

Embodiments disclose a server system including a first circuit board which includes a first socket connected to a memory controller via an electrical channel; and a second circuit board which is combined with the first socket such that signals are exchanged with the memory controller via at least one of the electrical channel and an optical channel. The optical channel is combined with the electrical channel via an electrical-to-optical conversion device, the electrical-to-optical conversion device converts an electrical signal into an optical signal or converts an optical signal into an electrical signal.

### CROSS-REFERENCE TO RELATED APPLICATIONS

This application claims the benefit of Korean Patent Application No. 10-2012-0041148, filed on Apr. 19, 2012, in the Korean Intellectual Property Office, the disclosure of which is incorporated herein in its entirety by reference.

### BACKGROUND

One or more aspects of the embodiments relate to a server system and a method of controlling the same. More particularly, embodiments relate to a server system having a complicated channel structure and a method of performing memory hierarchy control in the server system.

### RELATED ART

In a related art server system, memory modules are connected via an electrical channel. However, such a related art electrical channel-based connection mechanism is limited in terms of storage capacity and performance requirements, when system integration is performed in the related art server system.

### SUMMARY

Embodiments provide a server system capable of supporting an electrical connecting memory module (ECMM) and an optical connecting memory module (OCMM), while maintaining compatibility with the existing server system.

Embodiments also provide a memory hierarchy control method of improving latency of a server system that supports both an ECMM and an OCMM.

According to an aspect of the exemplary embodiments, there is provided a server system including: a first circuit board which includes a first socket connected to a memory controller via an electrical channel; and a second circuit board which is combined with the first socket such that signals are exchanged with the memory controller via at least one of the electrical channel and an optical channel, wherein the optical channel is combined with the electrical channel via an electrical-to-optical conversion device, the electrical-to-optical conversion device converts an electrical signal into an optical signal or converts an optical signal into an electrical signal.

The first circuit board and the second circuit board may be connected via the electrical channel by disposing a connection terminal on the second circuit board and combining the connection terminal with the first socket.

The electrical-to-optical conversion device may include: an electrical-to-optical converter for converting parallel electrical optical signals received from the memory controller via the electrical channel into first parallel optical signals; a serializer for converting the first parallel optical signals received from the electrical-to-optical converter into a serial optical signal; a deserializer for converting the serial optical signal received via the optical channel into second parallel optical signals; and an optical-to-electrical converter for converting the second parallel optical signals into electrical signals.

At least one optical connection memory module may be disposed on the second circuit board such that signals are exchanged with the memory controller via the optical channel.

The at least one optical connection memory module may include: a plurality of memory chips; and an optical-to-electrical conversion device for converting the optical signal received via the optical channel into the electrical signal, transmitting the electrical signal to the plurality of memory chips, converting the electrical signal received from the plurality of memory chips into another optical signal, and outputting the another optical signal via the optical channel.

The optical-to-electrical conversion device may include: a deserializer for converting a first serial optical signal received via the optical channel into first parallel optical signals; an optical-to-electrical converter for converting the first parallel optical signals into parallel electrical signals and transmitting the parallel electrical signals to the plurality of memory chips; an electrical-to-optical converter for converting the parallel electrical signals received via the plurality of memory chips into second parallel optical signals; and a serializer for converting the second parallel optical signals received from the electrical-to-optical converter into a second serial optical signal and transmitting the second serial optical signal via the optical channel.

The at least one optical connection memory module may be combined with a second socket disposed on the second circuit board, and wherein the second socket is connected to the optical channel.

A first connector may be disposed on the second circuit board, the second circuit board is connected to the optical channel.

The server system may further include a third circuit board connected to the first connector via an optical fiber, the third circuit board includes: a second connector connected to the optical channel; and a third socket connected to the second connector via the optical channel, wherein the third socket is connected to at least one optical connection memory module for exchanging signals with the memory controller via the optical channel.

At least one optical connection memory module and at least one electrical connection memory module may be disposed on the second circuit board, the at least one optical connection memory module exchanges signals with the memory controller via the optical channel and the at least one electrical connection memory module exchanges signals with the memory controller via the electrical channel connected to the first socket.

A second socket connected to the optical channel and a third socket connected to the first socket via the electrical channel may be disposed on the second circuit board, wherein the second socket is combined with the at least one optical connection memory module, and the third socket is combined with the at least one electrical connection memory module.

A fourth socket may be further disposed on the first circuit board, the fourth socket is connected to the memory controller via the electrical channel, and the fourth socket is combined with at least one electrical connection memory module for exchanging signals with the memory controller via the electrical channel, and wherein the first socket and the fourth socket are connected to a same signal channel.

A fifth socket may be disposed on the second circuit board, and the fifth socket is connected to the optical channel and the electrical channel, the fifth socket is combined with an electrical connection memory module which includes the electrical-to-optical conversion device.

The second circuit board may be replaced with an electrical connection memory module which includes the electrical-to-optical conversion device, wherein a first connector connected to the optical channel is disposed on the electrical connection memory module.

According to another aspect of the exemplary embodiments, there is provided a memory hierarchy control method performed in a server system that supports an electrical connection memory module and an optical connection memory module, the method including: determining whether accessed target data is stored in the electrical connection memory module if an access request occurs in the server system; reading the target data from the electrical connection memory module when it is determined that the target data is stored in the electrical connection memory module, and determining whether the target data is stored in the optical connection memory module when it is determined that the target data is not stored in the electrical connection memory module; and reading the target data from the optical connection memory module when it is determined that the target data is stored in the optical connection memory module, and accessing a storage device included in the server system when it is determined that the target data is not stored in the optical connection memory module.

According to a further aspect of the exemplary embodiments, there is provided a server system including a channel structure including: a first circuit board, which includes a plurality of sockets, the plurality of sockets are connected to a memory controller via an electrical channel; a second circuit board, which is combined with the plurality of sockets in signal units of the channel structure, such that signals are exchanged with the memory controller via an electrical channel and an optical channel; and at least one optical connection memory is disposed on the second circuit board such that signals are exchanged with the memory controller via the optical channel.

### BRIEF DESCRIPTION OF THE DRAWINGS

Exemplary embodiments of the embodiments will be more clearly understood from the following detailed description taken in conjunction with the accompanying drawings in which:

FIG. 1 illustrates a connected state of memory channels in a server system, according to an embodiment;

FIG. 2 is a block diagram of a server system according to an embodiment of;

FIG. 3 is a block diagram of a server system according to another embodiment;

FIG. 4 is a block diagram of a server system according to another embodiment;

FIG. 5 is a block diagram of a server system according to another embodiment;

FIGS. 6A and 6B illustrate various examples of an electric connection memory module (ECMM) of FIG. 3, according to embodiments;

FIGS. 7A and 7B are block diagrams of various examples of an optical connection memory module (OCMM) illustrated in FIG. 2 or 3, according to embodiments;

FIGS. 8A and 8B are block diagrams of various examples of an ECMM including an electrical-to-optical (EO) conversion unit illustrated in FIG. 5, according to an embodiment;

FIG. 9 illustrates a structure of an EO conversion unit of FIG. 2 or 3, according to an embodiment;

FIG. 10 illustrates a structure of an optical-to-electrical (OE) conversion unit of FIG. 7A or 7B, according to an embodiment;

FIG. 11 illustrates a structure of a first circuit board including a memory controller, according to an embodiment;

FIGS. 12A to 12D illustrate various examples of a second circuit board to be combined with sockets of the first circuit board of FIG. 11, according to embodiments;

FIGS. 13A and 13B illustrate various examples of a third circuit board to be combined with a second circuit board, according to embodiments;

FIGS. 14 to 18 illustrate various examples of a channel structure of a server system, according to embodiments;

FIG. 19 is a block diagram illustrating an entire structure of a server system, according to embodiments; and

FIG. 20 is a flowchart illustrating a method of performing memory hierarchy control in a server system, according to an embodiment.

### DETAILED DESCRIPTION OF THE EMBODIMENTS

Hereinafter, embodiments will be described more fully with reference to the accompanying drawings, in which exemplary embodiments of the are shown. Embodiments may, however, be embodied in many different forms and should not be construed as limited to the exemplary embodiments set forth herein. Rather, these embodiments are provided so that this disclosure will be thorough and complete, and will fully convey the scope of the embodiments to those of ordinary skilled in the art. Although a few embodiments have been shown and described, it would be appreciated by those of ordinary skill in the art that changes may be made in these exemplary embodiments without departing from the principles and spirit of the embodiments, the scope of which is defined in the claims and their equivalents. In the drawings, like reference numerals denote like elements, and the lengths and sizes of layers and regions may be exaggerated for clarity.

The terminology used herein is for the purpose of describing particular embodiments only and is not intended to be limiting of the embodiments. As used herein, the singular forms ‘a’, ‘an’, and ‘the’ are intended to include the plural forms as well, unless the context clearly indicates otherwise. It will be further understood that the terms ‘comprises’ and/or ‘comprising,’ when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, expressions such as “at least one of,” when preceding a list of elements, modify the entire list of elements and do not modify the individual elements of the list.

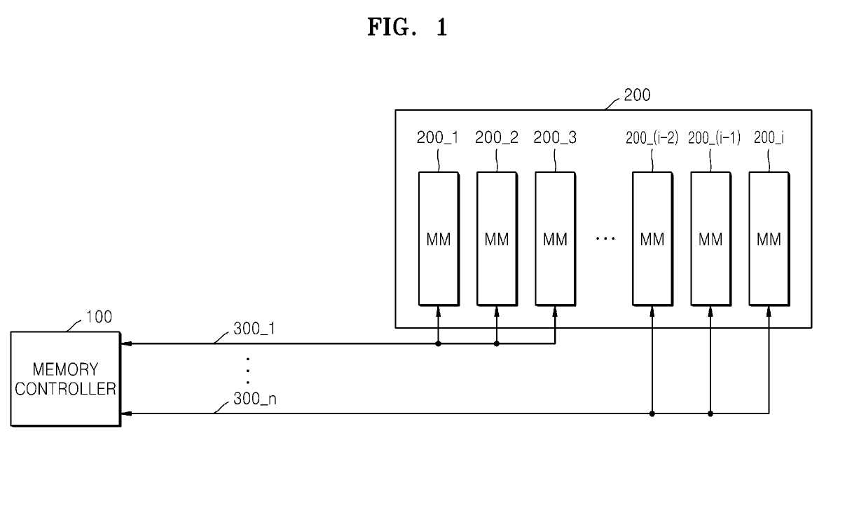

FIG. 1 illustrates a connected state of memory channels in a server system, according to an embodiment. Referring to FIG. 1, the server system includes a memory controller 100 and a memory module block 200.

The memory controller 100 generates signals for writing data to or reading data from a plurality of memory modules 200_1 to 200_{—}i. For example, the memory controller 100 may generate a command and an address signal.

The signals generated by the memory controller 100 are delivered to the plurality of memory modules 200_1 to 200_{—}i via an electrical channel and an optical channel. In other words, the command and the address signal generated by the memory controller 100 may be delivered to the plurality of memory modules 200_1 to 200_{—}i via buses 300_1 to 300_{—}n, forming an electrical channel.

The memory controller 100 may transmit or receive data from the plurality of memory modules 200_1 to 200_{—}i, via the buses 300_1 to 300_{—}n.

The memory module block 200 includes the plurality of memory modules 200_1 to 200_{—}i. In the memory module block 200, every three memory modules form one channel together, from among the plurality of memory modules 200_1 to 200_{—}i. However, embodiments are not limited thereto, and the number of memory modules forming one channel is not limited.

According to an embodiment, the memory modules 200_1 to 200_{—}i may be embodied as optical connection memory modules (OCMMs). According to another embodiment, the memory modules 200_1 to 200_{—}i may be embodied as a combination of OCMMs and electrical connection memory modules (ECMMs).

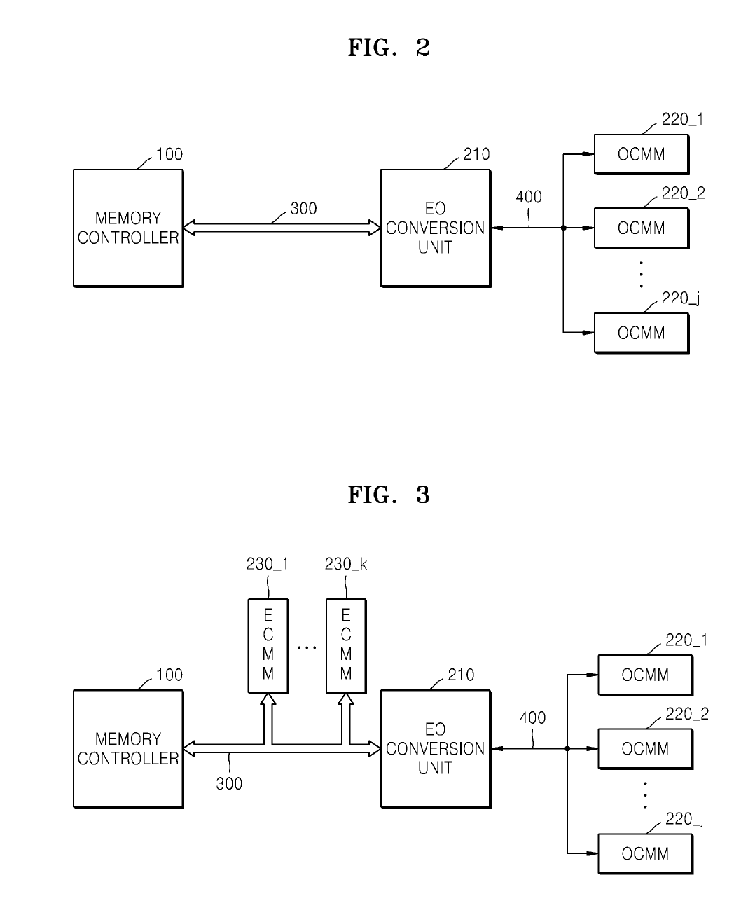

FIG. 2 is a block diagram of a server system according to an embodiment.

FIG. 2 illustrates a case where the memory modules 200_1 to 200_{—}i of FIG. 1 are embodied as OCMMs.

Referring to FIG. 2, the server system includes a memory controller 100, an electrical-to-optical (EO) conversion unit 210, and a plurality of OCMMs 220_1 to 220j. As another embodiment, one OCMM may be connected to an optical channel 400, instead of the plurality of OCMMs 220_1 to 220_{—}j.

The memory controller 100 is connected to the EO conversion unit 210 via an electrical channel 300. Thus, the memory controller 100 may exchange signals with the EO conversion unit 210 via the electrical channel 300.

For example, the memory controller 100 may transmit a command and an address signal to the EO conversion unit 210 via buses forming the electrical channel 300. Also, the memory controller 100 may transmit or receive data from the EO conversion unit 210 via the buses.

The EO conversion unit 210 converts an electrical signal received from the memory controller 100 into an optical signal and transmits the optical signal to the optical channel 400, and converts an optical signal received from the optical channel 400 into an electrical signal and transmits the electrical signal to the electrical channel 300, via the electrical channel 300. The EO conversion unit 210 is described in detail below.

The EO conversion unit 210 is connected to the OCMMs 220_1 to 220j via the optical channel 400.

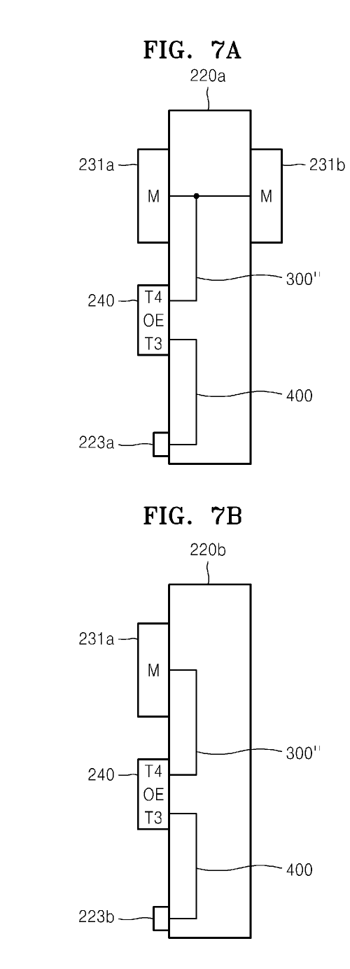

Although not shown, each of the OCMMs 220_1 to 220j includes a plurality of memory chips and an EO conversion unit. Examples of the OCMMs 220_1 to 220_{—}j are illustrated in FIGS. 7A and 7B.

FIG. 7A is a block diagram of an OCMM 220a, which is a dual in-line memory module, according to an embodiment. Referring to FIG. 7A, memory blocks 231a and 231b each include a plurality of memory chips, an optical-to-electrical (OE) conversion unit 240, and a connection terminal 223a are disposed on the OCMM 220a.

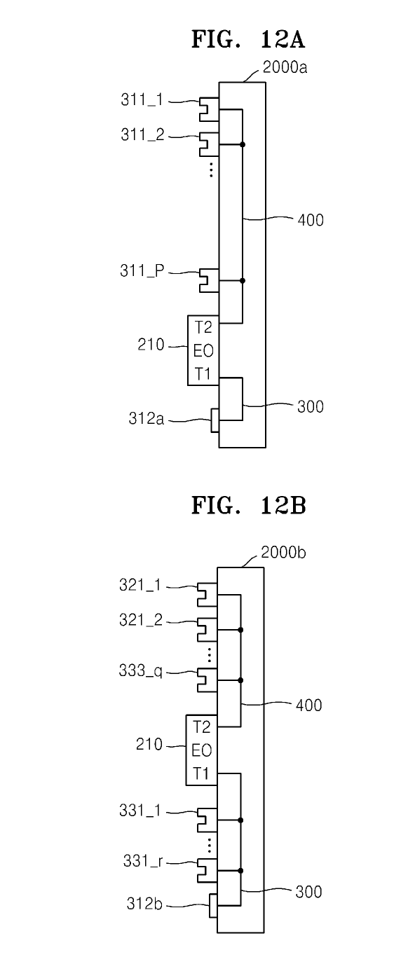

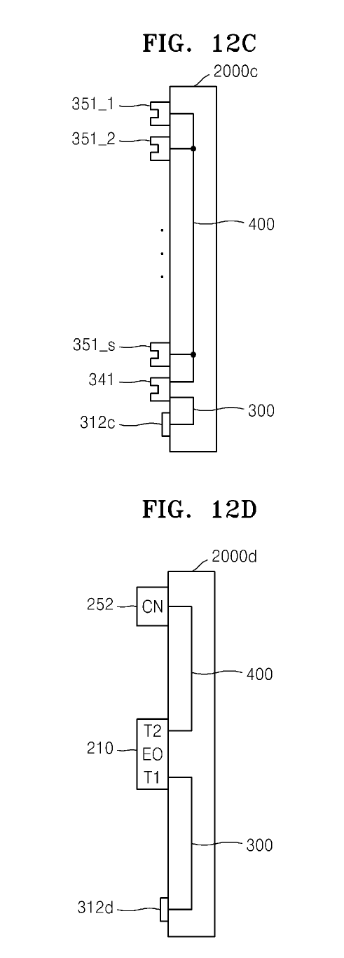

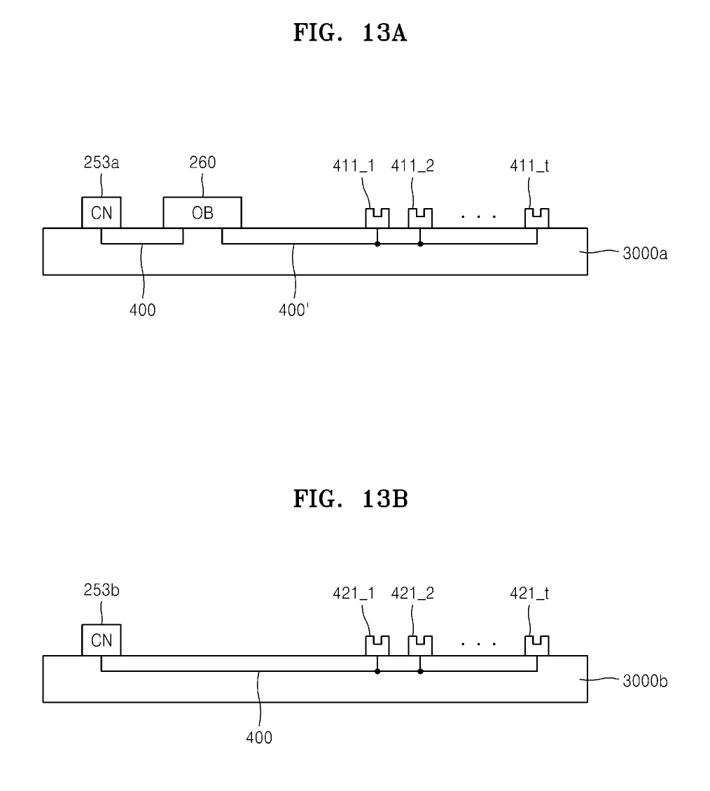

As illustrated in one of FIGS. 12A to 12D, the connection terminal 223a may be combined with sockets arranged in an optical channel of a second circuit board. Otherwise, as illustrated in one of FIGS. 13A and 13B, the connection terminal 223a may be combined with sockets connected to an optical channel of a third circuit board.

As illustrated in FIG. 10, the OE conversion unit 240 disposed in the OCMM 220a may be embodied as a circuit. The OE conversion unit 240 is described in detail below.

The OCMM 220a has a channel structure, in which the connection terminal 223a is connected to a terminal T3 of the OE conversion unit 240 via an optical channel 400 and the memory blocks 231a and 231b are connected to a terminal T4 of the OE conversion unit 240 via an electrical channel 300″. Specifically, each of the memory blocks 231a and 231b includes a plurality of memory chips, and the plurality of memory chips are connected to the terminal T4 of the OE conversion unit 240 via the electrical channel 300″. For example, the memory chips constituting the memory blocks 231a and 231b may include volatile semiconductor memory chips. Specifically, examples of the memory chips may include dynamic random access memory (DRAM) chips, static RAM (SRAM) chips, etc.

FIG. 7B is a block diagram of an OCMM 220b, which is a single in-line memory module, according to another embodiment. Referring to FIG. 7B, a memory block 231a includes a plurality of memory chips, an OE conversion unit 240, and a connection terminal 223b are disposed on the OCMM 220b.

As illustrated in FIG. 10, the OE conversion unit 240 disposed in the OCMM 220b may be embodied as a circuit.

The connection terminal 223b is connected to a terminal T3 of the OE conversion unit 240 via an optical channel 400 and the memory block 231a is connected to a terminal T4 of the OE conversion unit 240 via an electrical channel 300″. Specifically, the memory block 231a includes a plurality of memory chips, and the plurality of memory chips are connected to the terminal T4 of the OE conversion unit 240 via the electrical channel 300″.

The OE conversion unit 240, illustrated in FIGS. 7A and 7B, converts an optical signal received from the optical channel 400 via the terminal T3 into an electrical signal, transmits the electrical signal to the memory chips via the terminal T4, converts an electrical signal received from the memory chips via the terminal T4 into an optical signal, and transmits the optical signal to the optical channel 400 via the terminal T3. The OE conversion unit 240 is described in detail below.

FIG. 3 is a block diagram of a server system according to another embodiment. FIG. 3 illustrates a structure of a server system including a combination of a plurality of OCMMs 220_1 to 220j and a plurality of ECMMs 230_1 to 230_{—}k, instead of the plurality of memory modules 220_1 to 220_{—}j.

Referring to FIG. 3, the server system includes a memory controller 100, an EO conversion unit 210, the plurality of OCMMs 220_1 to 220j, and the plurality of ECMMs 230_1 to 230_{—}k.

According to another embodiment, one ECMM may be connected to an electrical channel 300, instead of the plurality of ECMMs 230_1 to 230_{—}k, and one OCMM may be connected to an optical channel 400, instead of the plurality of OCMMs 220_1 to 220_{—}j.

The memory controller 100 is connected to the ECMMs 230_1 to 230_{—}k and the EO conversion unit 210 via the electrical channel 300. Thus, the memory controller 100 may exchange signals with the ECMMs 230_1 to 230_{—}k and the EO conversion unit 210 via the electrical channel 300.

The EO conversion unit 210 is connected to the OCMMs 220_1 to 220j via the optical channel 400.

The EO conversion unit 210 and the OCMMS 220_1 to 220_{—}j are described above with reference to FIG. 2. Thus, detailed description of the EO conversion unit 210 and the OCMMS 220_1 to 220_{—}j are omitted.

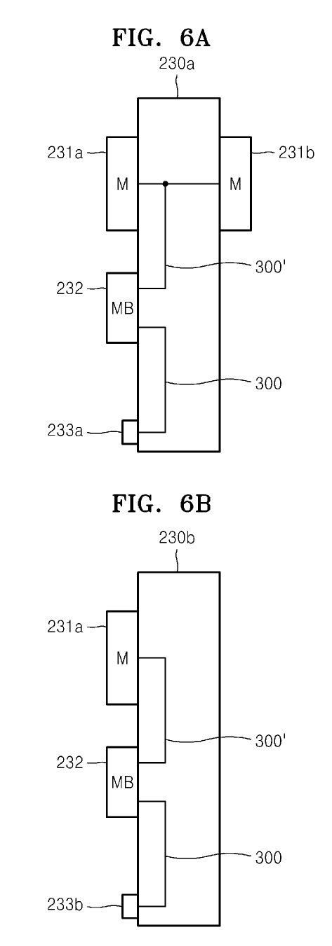

Although not shown, each of the ECMMs 230_1 to 230_{—}k includes a plurality of memory chips and a memory buffer. Examples of the ECMMs 230_1 to 230_{—}k are illustrated in FIGS. 6A and 6B.

FIG. 6A is a block diagram of an ECMM 230a, which is a dual in-line memory module, according to an embodiment. Referring to FIG. 6A, memory blocks 231a and 231b each include a plurality of memory chips, a memory buffer 232, and a connection terminal 233a are disposed on the ECMM 230a.

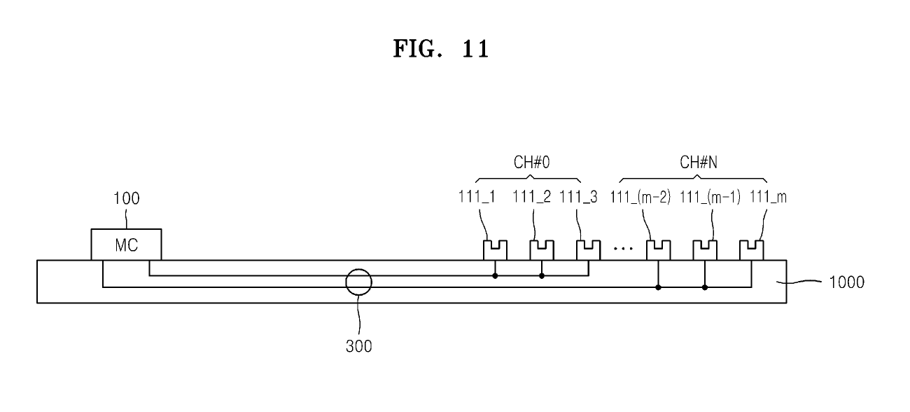

The connection terminal 233a may be combined with sockets, connected to an electrical channel 300 of a first circuit board 1000 in FIG. 11. The connection terminal 233a may also be combined with sockets, connected to an electric channel of a second circuit board, such as those illustrated in FIGS. 12A to 12D.

The connection terminal 233a is connected to one terminal of the memory buffer 231 via an electrical channel 300. Another terminal of the memory buffer 232 is connected the memory blocks 231a and 231b via an electrical channel 300′. Specifically, each of the memory blocks 231a and 231b includes a plurality of memory chips, and the plurality of memory chips are connected to the memory buffer 232 via the electrical channel 300′.

The memory buffer 232 is a semiconductor device that buffers and outputs an input signal. The memory buffer 232 may buffer data, a command signal, and an address signal, and supply them to the memory chips of the memory blocks 231a and 231b. For example, the buffered data, command signal, and address signal may be supplied to the memory chips using a register circuit (not shown).

FIG. 6B is a block diagram of an ECMM 230b, which is a single in-line memory module, according to another embodiment. Referring to FIG. 6B, a memory block 231a includes a plurality of memory chips, a memory buffer 232, and a connection terminal 233b are disposed on the ECMM 230b.

The connection terminal 233b may be combined with sockets connected to the electrical channel 300 of the first circuit board 1000 in FIG. 11. Otherwise, the connection terminal 233b may be combined with sockets connected to an electrical channel of a second circuit board, as illustrated in one of FIGS. 12A to 12D.

The connection terminal 233b is connected to one terminal of the memory buffer 232 via an electrical channel 300. Another terminal of the memory buffer 232 is connected to the memory block 231a via an electrical channel 300′. Specifically, the memory block 231a includes the plurality of memory chips, and the memory chips are connected to the memory block 231a via the electrical channel 300′.

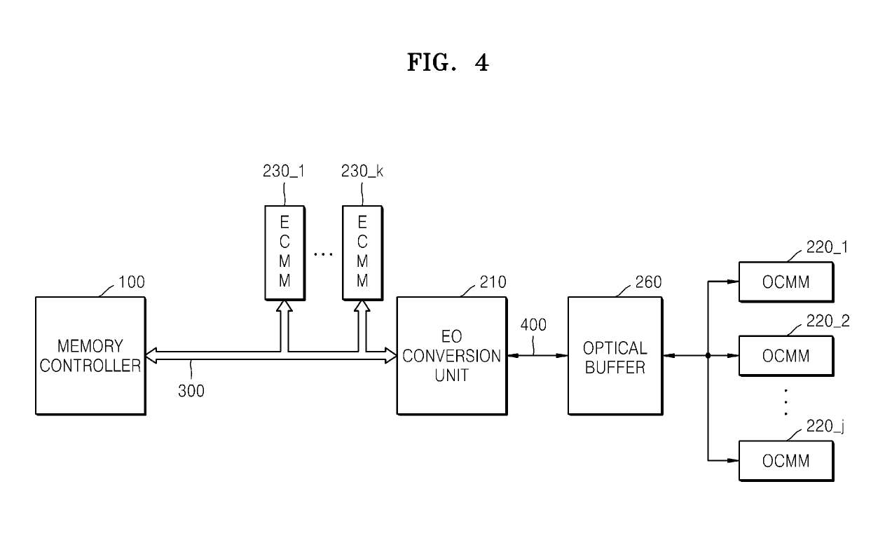

FIG. 4 is a block diagram of a server system according to another embodiment. FIG. 4 illustrates another example of a structure of a server system, including a combination of a plurality of OCMMs 220_1 to 220j and a plurality of ECMMs 230_1 to 230_{—}k, instead of the plurality of memory modules 220_1 to 220j.

Referring to FIG. 4, the server system includes a memory controller 100, an EO conversion unit 210, the plurality of OCMMs 220_1 to 220j, the plurality of ECMMs 230_1 to 230_{—}k, and an optical buffer 260.

In the server system of FIG. 4, the optical buffer 260 is further connected to an optical channel 400 between the EO conversion unit 210 and the plurality of OCMMs 220_1 to 220j, in comparison to the server system of FIG. 3.

The optical buffer 260 prevents loss or distortion of an optical signal in an optical waveguide forming the optical channel 400. For example, the optical buffer 260 may be embodied as a fiber delay line buffer, and may be designed to perform an operation similar to that of an electrical buffer.

The other elements of the server system of FIG. 4 are the same as those of the server system of FIG. 3, except for the optical buffer 260. Thus, detailed description of the other elements of the server system of FIG. 4, except for the optical buffer 260, are omitted.

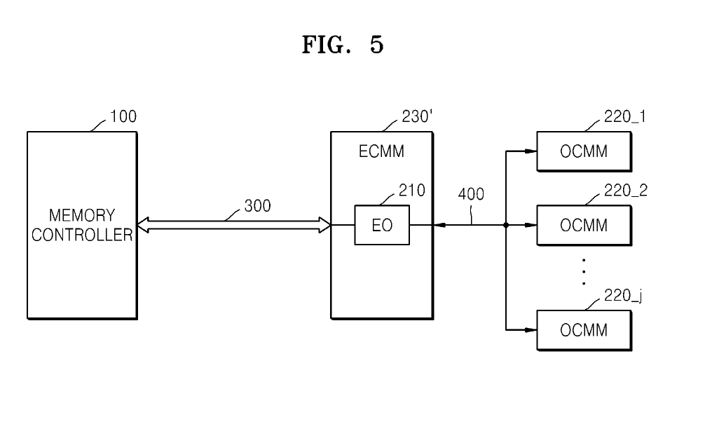

FIG. 5 is a block diagram of a server system according to another embodiment. FIG. 5 illustrates an example of a server system, including a combination of an ECMM 230′ having an EO conversion unit 210 and a plurality of OCMMs 220_1 to 220_{—}j.

Referring to FIG. 5, the server system includes a memory controller 100, the ECMM 230′ including the EO conversion unit 210, and the plurality of OCMMs 220_1 to 220_{—}j. According to another embodiment of, one OCMM may be connected to an optical channel 400, instead of the plurality of OCMMs 220_1 to 220_{—}j.

The memory controller 100 is connected to the ECMM 230′ including the EO conversion unit 210 via an electrical channel 300. The memory controller 100 may exchange signals with the ECMM 230′ via the electrical channel 300.

The OCMMS 220_1 to 220_{—}j are connected to the EO conversion unit 210 included in the ECMM 230′, via the optical channel 400.

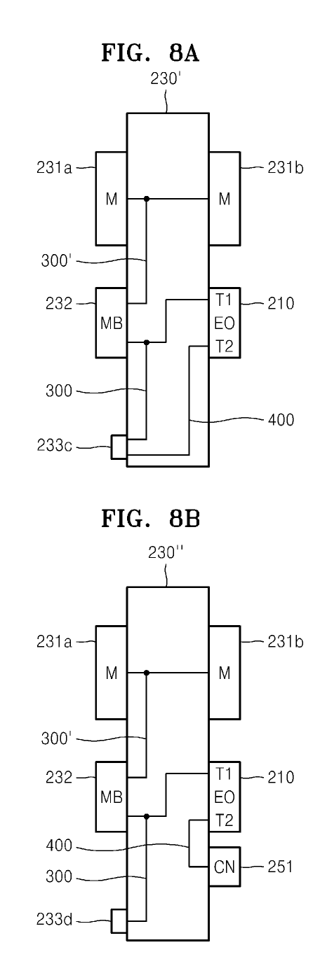

FIGS. 8A and 8B are block diagrams of various exemplary embodiments of an ECMM, including an EO conversion unit as illustrated in FIG. 5.

First, a structure of an ECMM according to an embodiment will now be described with reference to FIG. 8A.

Referring to FIG. 8A, memory blocks 231a and 231b each include a plurality of memory chips, a memory buffer 232, an EO conversion unit 210, and a connection terminal 233c are disposed on an ECMM 230′.

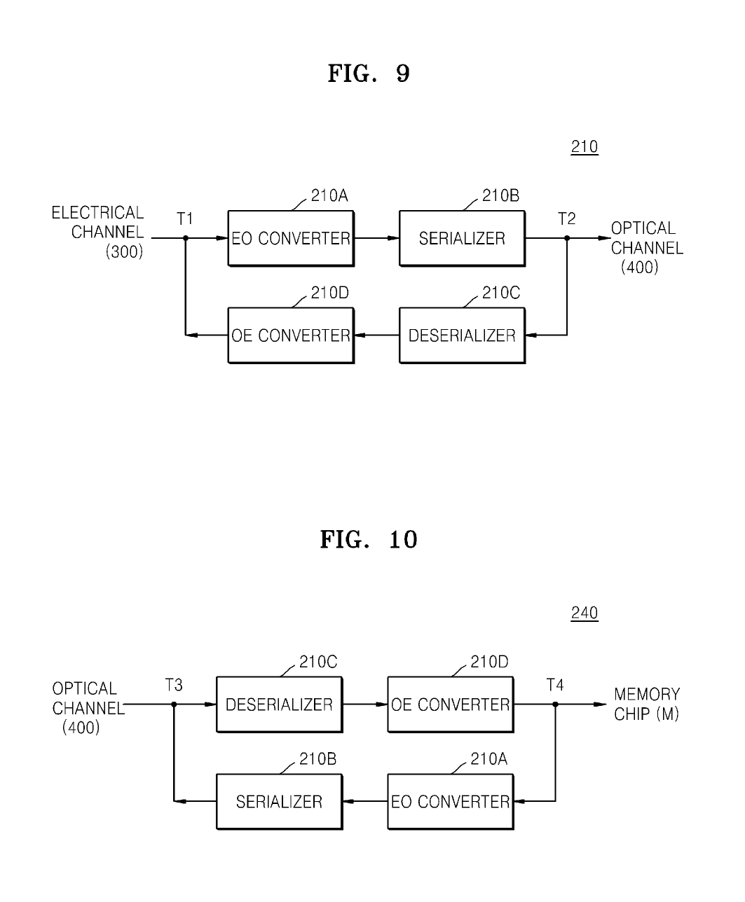

As illustrated in FIG. 9, the EO conversion unit 210 disposed in the ECMM 230′ may be embodied as a circuit.

Some terminals of the connection terminal 233c may be connected to an electrical channel 300. Other terminals of the connection terminal 233c may be connected to an optical channel 400.

Some terminals of the connection terminal 233c may be connected to a terminal T1 of the EO conversion unit 210 and the memory buffer 232. Other terminals of the connection terminal 233c are connected to a terminal T2 of the EO conversion unit 210.

The memory buffer 232 has a channel structure in which the memory buffer 232 is connected to the memory blocks 231a and 231b via an electrical channel 300′. Specifically, each of the memory blocks 231a and 231b includes a plurality of memory chips, and the plurality of memory chips are connected to the memory buffer 232 via the electrical channel 300′.

A structure of an ECMM, according to another embodiment, will now be described with reference to FIG. 8B.

Referring to FIG. 8B, memory blocks 231a and 231b each include a plurality of memory chips, a memory buffer 232, an EO conversion unit 210, a connector 251, and a connection terminal 233d are disposed on an ECMM 230″.

As illustrated in FIG. 9, the EO conversion unit 210 disposed in the ECMM 230″ may be embodied as a circuit.

The connection terminal 233d may be combined with sockets connected to the electrical channel 300, of the first circuit board 1000 in FIG. 11. Otherwise, the connection terminal 233d may be combined with sockets connected to an electrical channel of a second circuit board, as illustrated in one of FIGS. 12A to 12D.

The connection terminal 233d is connected to a terminal T1 of the EO conversion unit 210 and one terminal of the memory buffer 232 via the electrical channel 300. Another terminal of the memory buffer 232 is connected to the memory blocks 231a and 231b via an electrical channel 300′. Specifically, each of the memory blocks 231a and 231b includes a plurality of memory chips, and the memory chips are connected to the memory buffer 232 via the electrical channel 300′. A terminal T2 of the EO conversion unit 210 is connected to the connector 251.

A structure of the EO conversion unit 210, illustrated in FIG. 2 or 3, will be described in detail with reference to FIG. 9 below.

Referring to FIG. 9, an EO conversion unit 210 includes an EO converter 210A, a serializer 210B, a deserializer 210C, and an OE converter 210D.

The EO converter 210A converts parallel electrical signals, which are supplied to a terminal T1 from the memory controller 100 of FIG. 1 via an electrical channel 300, into parallel optical signals.

The serializer 210B converts the parallel optical signals received from the EO converter 210A into a serial optical signal. For example, the serial optical signal may be obtained by respectively delaying the parallel optical signals for different time periods by using an optical delayer (not shown) and combining the delayed parallel optical signals together by using an optical coupling device (not shown). The serial optical signal output from the serializer 210B is delivered from a terminal T2 to the OCMMs 220_1 to 220j, illustrated in one of FIGS. 2 to 5, via an optical channel 400.

The deserializer 210C converts a serial optical signal received, via the optical channel 400, into parallel optical signals. The serial optical signal supplied to the deserializer 210C is output from the OCMMS 220_1 to 220_{—}j.

The OE converter 210D converts the parallel optical signals received from the deserializer 210C into electrical signals. The electrical signals output from the OE converter 210D are delivered to the memory controller 100 via the electrical channel 300.

A structure of the OE conversion unit 240, illustrated in FIG. 7A or 7B according to an embodiment, will be described in detail with reference to FIG. 10.

Referring to FIG. 10, the OE conversion unit 240 includes an EO converter 210A, a serializer 210B, a deserializer 210C, and an EO converter 210D.

The EO converter deserializer 210C converts a serial optical signal, which is supplied to a terminal T3 via an optical channel 400, into parallel optical signals.

The EO converter 210D converts the parallel optical signals received from the deserializer 210C into electrical signals, and transmits the electrical signals to the memory chips of the OCMM 220a or 220b of FIG. 7A or 7B.

The EO converter 210A converts parallel electrical signals received from the memory chips of the OCMM 220a or 220b, into parallel optical signals.

The serializer 210B converts the parallel optical signals received from EO converter 210A into a serial optical signal. The serial optical signal, output from the serializer 210B, is delivered to the EO conversion unit 210 of FIG. 2, 3, or 4 via the optical channel 400.

As illustrated in FIGS. 9 and 10, the EO conversion unit 210 and the OE conversion unit 240 may be embodied as circuits that are substantially the same.

A structure of the first circuit board 1000, including a memory controller 100 thereon in a server system according to an embodiment, will be described with reference to FIG. 11.

In the server system, the first circuit board 1000, including the memory controller 100, is also referred to as a main board.

As illustrated in FIG. 11, on the first circuit board 1000, the memory controller 100 and a plurality of sockets 111_1 to 111_{—}m are disposed. The memory controller 100 and the plurality of sockets 111_1 to 111_{—}m are connected via the electrical channel 300. In other words, the memory controller 100 and the plurality of sockets 111_1 to 111_{—}m may exchange signals with one another via electrical buses. The electrical buses are electrical paths, and may be embodied as wires having high conductivity. However, electrical buses are not limited to wires having high conductivity.

FIG. 11 illustrates an example of a channel structure, in which three sockets are connected to one signal channel. In other words, three sockets 111_1, 111_2, and 111_3 may be connected to one signal channel CH #0. Three sockets 111_(m-2), 111_(m-1), and 111_{—}m may also be connected to another signal channel CH #N.

According to another embodiment, a server system may be designed such that one socket is connected to one signal channel, or such that at least two sockets are connected to one signal channel.

Referring to FIG. 11, in the first circuit board 1000 including the memory controller 100, the plurality of sockets 111_1 to 111_{—}m are connected via the electrical channel 300. The structure of the first circuit board 1000 is similar to a general structure of a server system.

According to an embodiment, a memory channel structure to which an optical connection channel structure is added. Therefore, restrictions of a memory channel having an electrical connection structure may be overcome, without changing the structure of the first circuit board 1000 corresponding to a main board of a general server system.

Various examples of a second circuit board, for adding an optical connection channel in a server system, without changing the structure of the first circuit board 1000, according to embodiments will now be described.

FIGS. 12A to 12D illustrate various examples of a second circuit board to be combined with sockets of the first circuit board 1000 of FIG. 11, according to embodiments.

Second circuit boards 2000a to 2000d, illustrated in FIGS. 12A to 12D, are combined with sockets of the first circuit board 1000. The second circuit boards 2000a to 2000d may also be referred to as interposer boards.

Each of the second circuit boards 2000a to 2000d may be combined with the plurality of sockets 111_1 to 111_{—}m, disposed on the first circuit board 1000.

The second circuit board 2000a of FIG. 12A will now be described. Referring to FIG. 12A, on the second circuit board 2000a, an EO conversion unit 210, a plurality of sockets 311_1 to 311_{—}p, and a connection terminal 312a are disposed.

As illustrated in FIG. 9, the EO conversion unit 210, disposed on the second circuit board 2000a, may be embodied as a circuit.

In the second circuit board 2000a, the connection terminal 312a is connected to a terminal T1 of the EO conversion unit 210 via an electrical channel 300, and a terminal T2 of the EO conversion unit 210 is connected to the plurality of sockets 311_1 to 311_{—}p via an optical channel 400. The optical channel 400 may be an optical communication bus, e.g., an optical waveguide.

When the second circuit board 2000a is combined with a selected socket, from among the plurality of sockets 111_1 to 111_{—}m of the first circuit board 1000, the connection terminal 312a of the second circuit board 2000a is connected to the electrical channel 300 via the selected socket.

Thus, the memory controller 100 of the first circuit board 1000 and the EO conversion unit 210 of the second circuit board 2000a may be combined with each other via the electrical channel 300.

Each of the plurality of sockets 311_1 to 311_{—}p may be combined with the OCMM 220a or 220b of FIG. 7A or 7B

Thus, the memory controller 100 of the first circuit board 1000 may exchange signals with memory chips of OCMMs, connected to the plurality of sockets 311_1 to 311_{—}p of the second circuit board 2000a, via the electrical channel 300 and the optical channel 400.

The second circuit board 2000b of FIG. 12B will be described. Referring to FIG. 12B, on the second circuit board 2000b, an EO conversion unit 210, a plurality of sockets 321_1 to 321_{—}q and 331_1 to 331_{—}r, and a connection terminal 312b are disposed.

As illustrated in FIG. 9, the EO conversion unit 210 disposed on the second circuit board 2000b may be embodied as a circuit.

In the second circuit board 2000b, the connection terminal 312b is connected to a terminal T1 of the EO conversion unit 210 and the sockets 331_1 to 331_{—}r via an electrical channel 300. A terminal T2 of the EO conversion unit 210 is connected to the sockets 321_1 to 321_{—}q via an optical channel 400.

When the second circuit board 2000b is combined with a selected socket, from among the plurality of sockets 111_1 to 111_{—}m of the first circuit board 1000, the connection terminal 312b of the second circuit board 2000b is connected to the selected socket.

Thus, the memory controller 100 of the first circuit board 1000, the sockets 331_1 to 331_{—}r, and the EO conversion unit 210 of the second circuit board 2000b may be combined with one another via the electrical channel 300. The memory controller 100 of the first circuit board 1000 may be combined with the sockets 321_1 to 321_{—}q via the electrical channel 300 and the optical channel 400.

The sockets 331_1 to 331_{—}r may also be combined with the ECMM 230a or 230b illustrated in FIG. 6A or 6B. The sockets 321_1 to 321_{—}q may also be combined with the OCMM 220a or 220b, as illustrated in FIG. 7A or 7B.

Thus, the memory controller 100 of the first circuit board 1000 may exchange signals with the memory chips of the ECMM 230a or 230b connected to the sockets 231_1 to 231_{—}r of the second circuit board 2000b, via the electrical channel 300. Also, the memory controller 100 of the first circuit board 1000 may exchange signals with the memory chips of the OCMM 220a or 220b connected to the sockets 221_1 to 221_{—}q of the second circuit board 2000b, via the electrical channel 300 or the optical channel 400.

The second circuit board 2000c of FIG. 12C will now be described. Referring to FIG. 12C, on the second circuit board 2000c, a plurality of sockets 341 and 351_1 to 351_{—}s and a connection terminal 312c are disposed.

In the second circuit board 2000c, the connection terminal 312c is connected to some terminals of the socket 341 via an electrical channel 300. Other terminals of the socket 341 are connected to the sockets 351_1 to 351_{—}s via an optical channel 400.

When the second circuit board 2000c is combined with a selected socket, from among the plurality of sockets 111_1 to 111_{—}m of the first circuit board 1000, the connection terminal 312c of the second circuit board 2000c is connected to the electrical channel 300 via the selected socket.

Thus, the memory controller 100 of the first circuit board 1000 and the socket 341 of the second circuit board 2000b may be combined via the electrical channel 300. Also, the memory controller 100 of the first circuit board 1000 may be combined with the sockets 351_1 to 351_{—}s via the electrical channel 300 and the optical channel 400.

The socket 341 may be combined with the ECMM 230′, including the EO conversion unit 210, illustrated in FIG. 8A. The sockets 261_1 to 261_{—}s may be combined with the OCMM 220a or 220b of FIG. 7A or 7B.

Thus, the memory controller 100 of the first circuit board 1000 may exchange signals with the memory chips of the ECMM 230′ connected to the socket 341 of the second circuit board 2000c, via the electrical channel 300. Also, the memory controller 100 of the first circuit board 1000 may exchange signals with the memory chips of the OCMM 220a or 220b, connected to the sockets 351_1 to 351_{—}s of the second circuit board 2000c, via the electrical channel 300 and the optical channel 400.

The second circuit board 2000d of FIG. 12D will now be described.

Referring to FIG. 12d, on the second circuit board 2000d, an EO conversion unit 210, a connector 252, and a connection terminal 312d are disposed.

As illustrated in FIG. 9, the EO conversion unit 210, disposed on the second circuit board 2000d, may be embodied as a circuit.

In the second circuit board 2000d, the connection terminal 312d is connected to a terminal T1 of the EO conversion unit 210 via an electrical channel 300. A terminal T2 of the EO conversion unit 210 is connected to the connector 252 via an optical channel 400.

When the second circuit board 2000d is combined with a selected socket, from among the plurality of sockets 111_1 to 111_{—}m of the first circuit board 1000, the connection terminal 312d of the second circuit board 2000d is connected to the electrical channel 300 via the selected socket.

Thus, the memory controller 100 of the first circuit board 1000 and the EO conversion unit 210 of the second circuit board 2000d may be combined with each other via the electrical channel 300. Also, the memory controller 100 of the first circuit board 1000 may be combined with the connector 252 via the electrical channel 300 and the optical channel 400.

The connector 252 may be connected to an optical fiber (not shown). Thus, the second circuit board 2000d may be connected to a third circuit board, via the optical channel 400 by using the optical fiber connected to the connector 252.

FIGS. 13A and 13B illustrate various examples of a third circuit board to be combined with a second circuit board, according to embodiments.

A third circuit board 3000a of FIG. 13A will be described. Referring to FIG. 13A, a connector 253a, an optical buffer 260, and a plurality of sockets 411_1 to 411_{—}t are disposed on the third circuit board 3000a.

In the third circuit board 3000a, the connector 253a is connected to the optical buffer 260 via an optical channel 400, and the optical buffer 260 is connected to the plurality of sockets 411_1 to 411_{—}t via an optical channel 400′.

Each of the plurality of sockets 411_1 to 411_{—}t may be combined with the OCMM 220a or 220b, illustrated in FIG. 7A or 7B.

When the connector 253a of the third circuit board 3000a and the connector 252 of the second circuit board 2000d of FIG. 12D are combined via an optical fiber (not shown), the memory controller 100 of the first circuit board 1000 of FIG. 11 may exchange signals with memory chips of OCMMs connected to the plurality of sockets 411_1 to 411_{—}t of the third circuit board 3000a, via the electrical channels 300 and the optical channels 400 and 400′ on the second circuit board 2000d and the third circuit board 3000a.

A third circuit board 3000b of FIG. 13B will now be described.

Referring to FIG. 13B, a connector 253b and a plurality of sockets 421_1 to 421_{—}t are disposed on the third circuit board 3000b.

In the third circuit board 3000b, the connector 253b is connected to a plurality of sockets 321_1 to 321_{—}t via an optical channel 400.

Each of the plurality of sockets 321_1 to 321_{—}t may be combined with the OCMM 220a or 220b.

When the connector 253b of the third circuit board 3000b and the connector 252 of the second circuit board 2000d are combined with each other via an optical fiber (not shown), the memory controller 100 of the first circuit board 1000 of FIG. 11 may exchange signals with memory chips of OCMMs connected to the plurality of sockets 411_1 to 411_{—}t of the third circuit board 3000b, via the electrical channels 300 and the optical channels 400 on the second circuit board 2000d of FIG. 12D and the third circuit board 3000b.

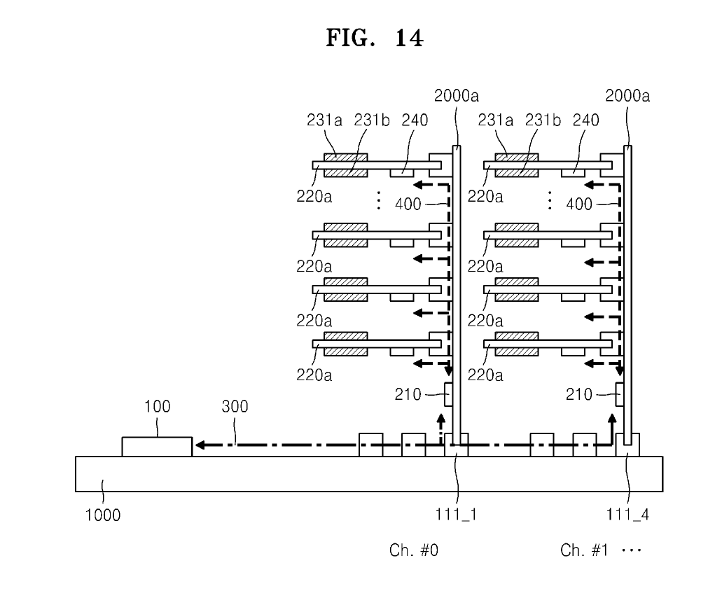

FIGS. 14 to 18 illustrate various examples of a channel structure of a server system, according to embodiments.

A channel structure of a server system according to an embodiment is illustrated in FIG. 14. Referring to FIG. 14, in the server system, the second circuit board 2000a of FIG. 12A is combined with the plurality of sockets 111_1 to 111_{—}m of the first circuit board 1000 of FIG. 11. For example, the server system may be designed in such a manner that one second circuit board 2000a is connected to the first circuit board 1000 in units of signal channels.

The server system of FIG. 14 has a channel structure, in which memory chips included in each of a plurality of memory blocks 231a and 231b, are connected to the memory controller 100 via an electrical channel 300 and an optical channel 400. In the case of such a server system including OCMMs, the storage capacity may be increased.

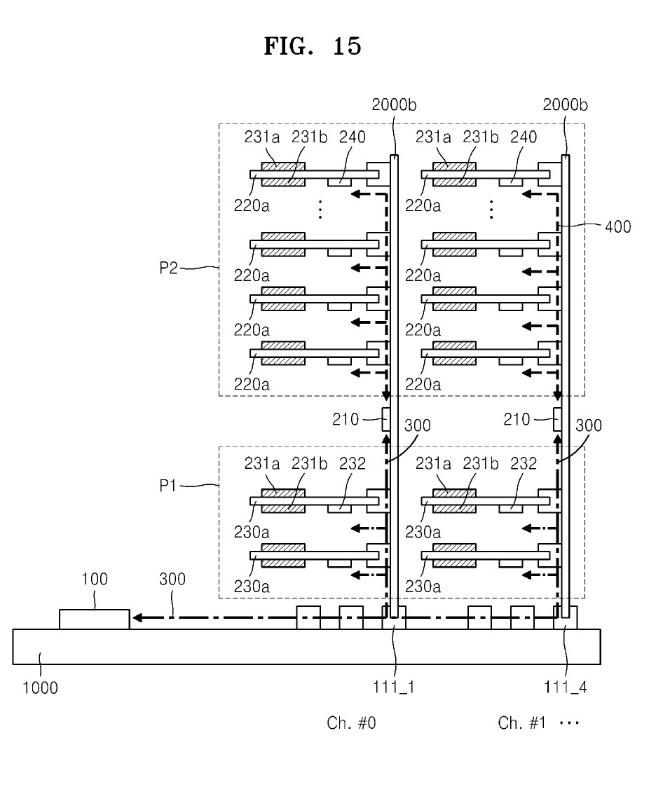

A channel structure of a server system, according to another embodiment, is illustrated in FIG. 15. Referring to FIG. 15, in the server system, the second circuit board 2000b of FIG. 12B is combined with the plurality of sockets 111_1 to 111_{—}m of the first circuit board 1000 in FIG. 11. For example, the server system may be designed in such a manner that one second circuit board 2000b is connected to the first circuit board 1000 in units of signal channels. From among the plurality of sockets 111_1 to 111_{—}m, sockets connected to the electrical channel 300 of the second circuit board 2000b may be combined with ECMMs 230a, and sockets connected to the optical channel 400 of the second circuit board 2000b may be combined with OCMMs 220a.

In the server system of FIG. 15, memory chips of each of the ECMMs 230a included in an area P1 are connected to the memory controller 100 via the electrical channel 300, and memory chips of each of the OCMMs 220a included in an area P2 are connected to the memory controller 100 via the electrical channel 300 and the optical channel 400.

Since the ECMMs 230a included in the area P1 are connected to the memory controller 100 via the electrical channel 300, the latency of the server system may be low, and the storage capacity may also be low. Since the OCMMs 220a included in the area P2 are connected to the memory controller 100 via the electrical channel 300 and the optical channel 400, the storage capacity of the server system may be high, and the latency may also be low.

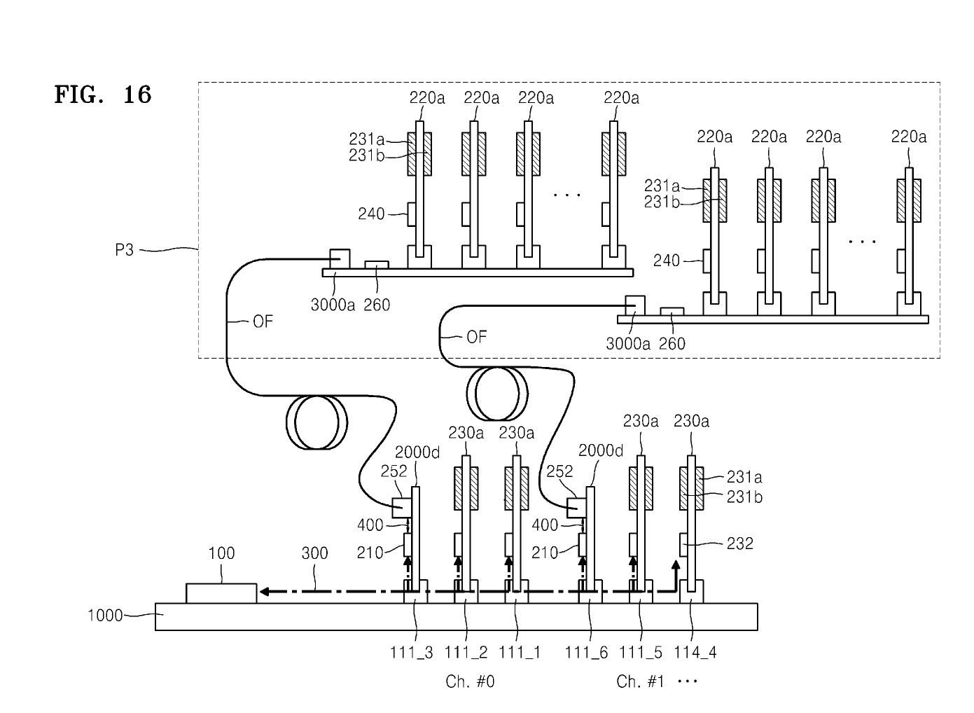

FIG. 16 illustrates a channel structure of a server system according to another embodiment. Referring to FIG. 16, in the server system, the ECMM 230a of FIG. 6A and the second circuit board 2000d of FIG. 12D are combined with the plurality of sockets 111_1 to 111_{—}m of the first circuit board 1000 in FIG. 11. For example, the server system may be designed such that one second circuit board 2000d and two ECMMs 230a are connected to the first circuit board 1000 in units of signal channels. The second circuit board 2000d may also be connected to the third circuit board 3000a or 3000b of FIG. 3A or 3B via an optical fiber.

The server system of FIG. 16 includes ECMMs 230a and OCMMs 220a. Thus, the third circuit board 3000a or 3000b may be connected to the server system via the optical channel 400. Thus, the server system may have a high storage capacity. Also, low latency of the server system may be overcome when the ECMMs 230a are included in the server system.

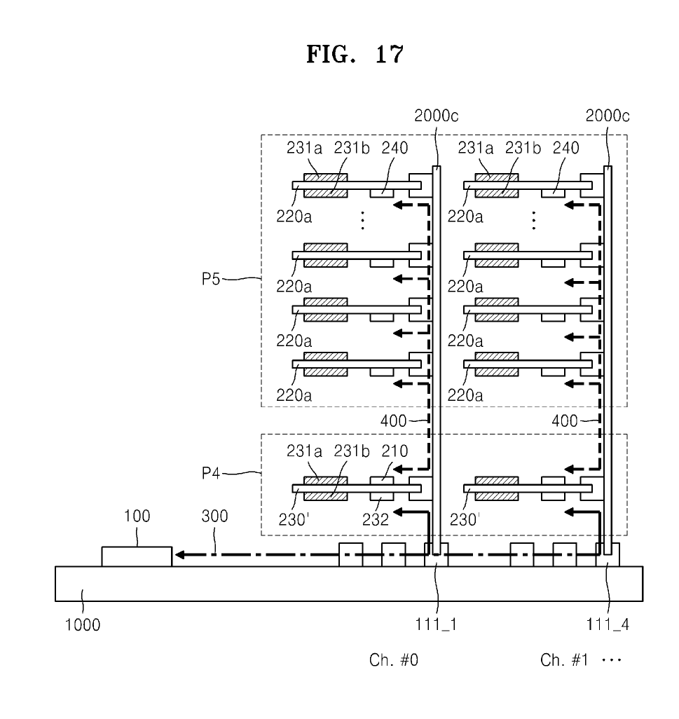

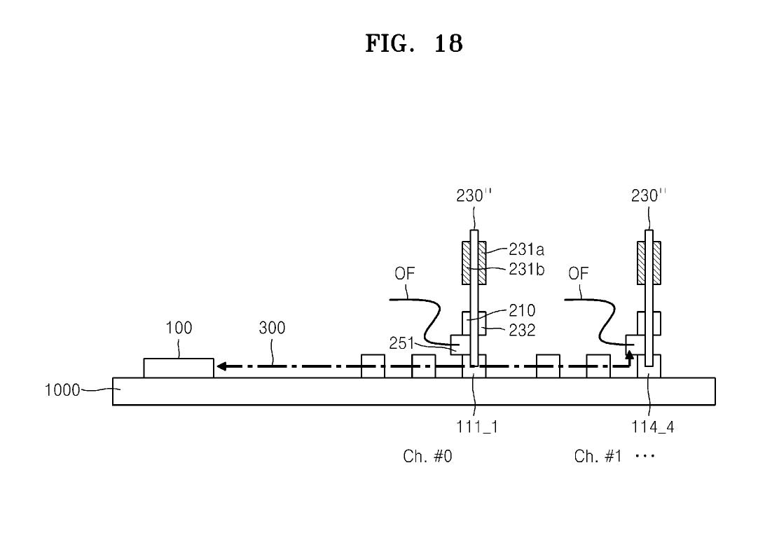

FIG. 17 illustrates a channel structure of a server system, according to an embodiment. Referring to FIG. 17, in the server system, the plurality of sockets 111_1 to 111_{—}m of the first circuit board 1000 of FIG. 11 are combined with the second circuit board 2000c of FIG. 12C. For example, the server system may be designed in such a manner that one second circuit board 2000c is connected to the first circuit board 1000 in units of signal channels. From among the plurality of sockets 111_1 to 111_{—}m, sockets connected to the optical channel 400 of the second circuit board 2000c are combined with OCMMs 220a and sockets connected to the electric channel 300 and the optical channel 400 of the second circuit board 2000c may be connected to ECMMs 230′, each including the EO conversion unit 210 of FIG. 8A.

Since the OCMMs 220a included in an area P5 are connected to the memory controller 100 via the electric channel 300 and the optical channel 400, the storage capacity of the server system is high, and latency is high. Since the ECMMs 230′ included in an area P4 are connected to the memory controller 100 via the electrical channel 300, the latency of the server system is low.

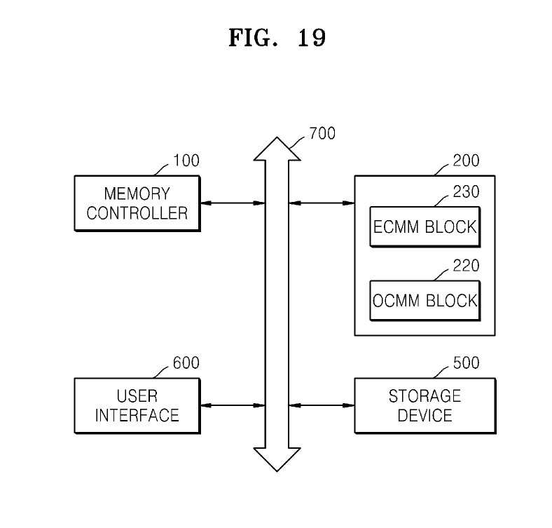

A channel structure of a server system according to another embodiment, is illustrated in FIG. 18. Referring to FIG. 18, in the server system, the plurality of sockets 111_1 to 111_{—}m of the first circuit board 1000 of FIG. 11 are combined with the ECMM 230″ including the EO conversion unit 210 and the connector 251, as illustrated in FIG. 3B. For example, the server system may be designed in such a manner that one ECMM 230″ is connected to the first circuit board 1000 in units of signal channels.

Also, the ECMM 230″ may be connected to the third circuit board 3000a or 3000b of FIG. 13A or 13B via an optical fiber. Thus, the storage capacity of the server system may be high. Also, it is possible to compensate for low latency of the server system when the ECMMs 230″ are included in the server system.

The first circuit boards 1000, each include the memory controller 100 respectively employed in the server systems of FIGS. 14 to 18, are the same. The server systems of FIGS. 14 to 18 have different channel structures according to the types of a second circuit board or memory modules therein. Thus, not only ECMMs, but also OCMMs, may be used in a server system according to a channel structure without changing a structure of a main board of the server system. Accordingly, storage capacity may be increased, while maintaining lower compatibility.

An entire structure of a server system according to an embodiment will now be described.

FIG. 19 is a block diagram illustrating an entire structure of a server system according to an embodiment. Referring to FIG. 19, the server system includes a memory controller 100, a memory module block 200, a storage device 500, a user interface 600, and a bus 700.

As illustrated in FIGS. 1 to 5, the server system may be designed in such a manner that the memory controller 100 and the memory module block 200 may have structures. As illustrated in FIGS. 14 to 18, the memory controller 100 and the memory module block 200 may each have a channel structure.

The elements of the server system may be connected to one another via the bus 700. Examples of the bus 700 include an electrical bus and an optical communication bus.

The user interface 600 may include input devices, e.g., a keyboard, a mouse, and a touch pad, or output devices, e.g., a display device and a printer.

The memory controller 100 generates signals to read data from the memory module block 200 or the storage device 300 or write data to the storage device 500, according to a signal received via the user interface 600.

For example, the memory controller 100 may generate a command and an address signal to read data from or write data to the memory module block 200 or the storage device 500.

The memory module block 200 may include an ECMM block 230 and an OCMM block 220. At least one ECMM may be included in the ECMM block 230, and at least one OCMM may be included in the OCMM block 220.

The storage device 500 may be embodied as, e.g., a nonvolatile storage device. Particularly, the storage device 500 may be embodied as a hard disc drive or an optical disc drive.

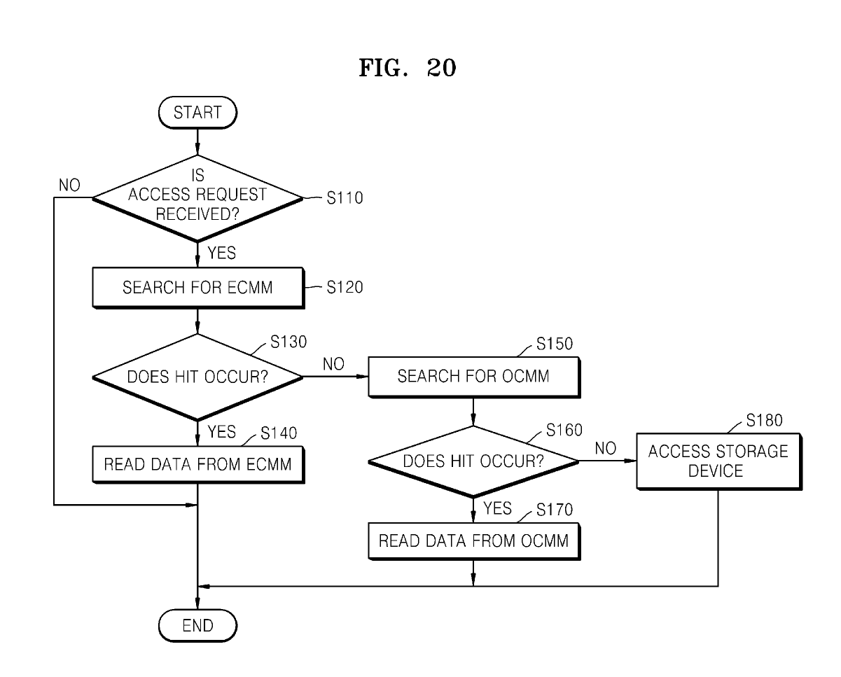

A method of performing memory hierarchy control in a server system by using the memory controller 100 of FIG. 19 according to an embodiment, will now be described with reference to FIG. 20.

FIG. 20 is a flowchart illustrating a method of performing memory hierarchy control in a server system, according to an embodiment.

Referring to FIGS. 19 and 20, the memory controller 100 determines whether an access request is received from the server system (operation 5110). The access request may be generated according to a read command or a write command.

If it is determined in operation 5110 that the access request is received from the server system, the memory controller 100 controls the server system to search for the ECMM block 230 included in the memory module block 200 (operation S120). Thus, the memory controller 100 accesses the at least one ECMM included in the ECMM block 230.

Then, the memory controller 100 determines whether a hit occurs while accessing the at least one ECMM (operation S130). While the at least one ECMM is accessed, a hit status may occur when target data that is to be accessed is stored in the ECMM block 230. A miss status occurs when the target data is not stored in the ECMM block 230.

If it is determined in operation 5130 that a hit status occurs, the memory controller 100 controls the server system to read the target data from the ECMM block 230 (operation S140).

If it is determined in operation 5130 that a miss status occurs, the memory controller 100 controls the server system to search for the OCMM block 220 included in the memory module block 200 (operation S 150).

Then, the memory controller 100 determines whether a hit occurs while accessing the at least one OCMM included in the OCMM block 220 (operation S160). While accessing the at least one OCMM, a hit status may occur when the target data is stored in the OCMM block 220. A miss status may occur when the target data is not stored.

If it is determined in operation S160 that a hit occurs, the memory controller 100 controls the server system to read the target data from the OCMM block 220 (operation S170).

If it is determined in operation 5160 that a miss status occurs, the memory controller 100 controls the server system to access the storage device 500, to read the target data from the storage device 500 (operation S 180).

By performing the method of FIG. 20, it is possible to reduce high latency of the server system, caused when an OCMM is added to the server system supporting an ECMM and an OCMM.

While the embodiments have been particularly shown and described with reference to exemplary embodiments thereof, it will be understood that various changes in form and details may be made therein without departing from the spirit and scope of the following claims.

What is claimed is:

1. A server system comprising:
a first circuit board which includes a first socket connected to a memory controller via an electrical channel; and
a second circuit board which is combined with the first socket such that signals are exchanged with the memory controller via at least one of the electrical channel and an optical channel,
wherein the optical channel is combined with the electrical channel via an electrical-to-optical conversion device, the electrical-to-optical conversion device converts an electrical signal into an optical signal or converts an optical signal into an electrical signal.

2. The server system of claim 1, wherein the first circuit board and the second circuit board are connected via the electrical channel by disposing a connection terminal on the second circuit board and combining the connection terminal with the first socket.

3. The server system of claim 1, wherein the electrical-to-optical conversion device comprises:
an electrical-to-optical converter which converts parallel electrical optical signals received from the memory controller via the electrical channel into first parallel optical signals;
a serializer which converts the first parallel optical signals received from the electrical-to-optical converter into a serial optical signal;
a deserializer which converts the serial optical signal received via the optical channel into second parallel optical signals; and
an optical-to-electrical converter which converts the second parallel optical signals into electrical signals.

4. The server system of claim 1, wherein, at least one optical connection memory module is disposed on the second circuit board such that signals are exchanged with the memory controller via the optical channel.

5. The server system of claim 4, wherein the at least one optical connection memory module comprises:
a plurality of memory chips; and
an optical-to-electrical conversion device which converts the optical signal received via the optical channel into the electrical signal, transmits the electrical signal to the plurality of memory chips, converts the electrical signal received from the plurality of memory chips into another optical signal, and outputs the another optical signal via the optical channel.

6. The server system of claim 5, wherein the optical-to-electrical conversion device comprises:
a deserializer which converts a first serial optical signal received via the optical channel into first parallel optical signals;
an optical-to-electrical converter which converts the first parallel optical signals into parallel electrical signals and transmitting the parallel electrical signals to the plurality of memory chips;
an electrical-to-optical converter which converts the parallel electrical signals received via the plurality of memory chips into second parallel optical signals; and
a serializer which converts the second parallel optical signals received from the electrical-to-optical converter into a second serial optical signal and transmitting the second serial optical signal via the optical channel.

7. The server system of claim 4, wherein the at least one optical connection memory module is combined with a second socket disposed on the second circuit board, and
wherein the second socket is connected to the optical channel.

8. The server system of claim 1, wherein a first connector is disposed on the second circuit board, the second circuit board is connected to the optical channel.

9. The server system of claim 8, further comprising:
a third circuit board connected to the first connector via an optical fiber,
the third circuit board comprises:
a second connector connected to the optical channel; and
a third socket connected to the second connector via the optical channel,
wherein the third socket is connected to at least one optical connection memory module for exchanging signals with the memory controller via the optical channel.

10. The server system of claim 1, wherein, at least one optical connection memory module and at least one electrical connection memory module is disposed on the second circuit board, the at least one optical connection memory module exchanges signals with the memory controller via the optical channel and the at least one electrical connection memory module exchanges signals with the memory controller via the electrical channel connected to the first socket.

11. The server system of claim 10, wherein, a second socket connected to the optical channel and a third socket connected to the first socket via the electrical channel is disposed on the second circuit board,
wherein the second socket is combined with the at least one optical connection memory module, and the third socket is combined with the at least one electrical connection memory module.

12. The server system of claim 1, wherein, a fourth socket is further disposed on the first circuit board, the fourth socket is connected to the memory controller via the electrical channel, and the fourth socket is combined with at least one electrical connection memory module for exchanging signals with the memory controller via the electrical channel, and
wherein the first socket and the fourth socket are connected to a same signal channel.

13. The server system of claim 1, wherein, a fifth socket is disposed on the second circuit board, and the fifth socket is connected to the optical channel and the electrical channel, the fifth socket is combined with an electrical connection memory module which includes the electrical-to-optical conversion device.

14. The server system of claim 1, wherein the second circuit board is replaced with an electrical connection memory module which includes the electrical-to-optical conversion device, and
wherein a first connector connected to the optical channel is disposed on the electrical connection memory module.

15. A memory hierarchy control method performed in a server system that supports an electrical connection memory module and an optical connection memory module, the method comprising:
determining whether accessed target data is stored in the electrical connection memory module if an access request occurs in the server system;
reading the target data from the electrical connection memory module when it is determined that the target data is stored in the electrical connection memory module, and determining whether the target data is stored in the optical connection memory module when it is determined that the target data is not stored in the electrical connection memory module; and
reading the target data from the optical connection memory module when it is determined that the target data is stored in the optical connection memory module, and accessing a storage device included in the server system when it is determined that the target data is not stored in the optical connection memory module.

16. A server system including a channel structure, comprising:
a first circuit board, which includes a plurality of sockets, the plurality of sockets are connected to a memory controller via an electrical channel;
a second circuit board, which is combined with the plurality of sockets in signal units of the channel structure, such that signals are exchanged with the memory controller via an electrical channel and an optical channel; and
at least one optical connection memory module is disposed on the second circuit board such that signals are exchanged with the memory controller via the optical channel.

17. The server system including the channel structure of claim 16, wherein the at least one optical connection memory module includes a plurality of memory chips.

18. The server system including the channel structure of claim 16, wherein an electrical-to-optical conversion device is disposed on the second circuit board which converts an electrical signal into an optical signal.

19. The server system including the channel structure of claim 16, wherein an optical-to-electrical conversion device is disposed on the second circuit board which converts an optical signal into an electrical signal.
